(19) United States
(12) Patent Application Publication
(10) Pub. No.: US 2005/0068762 A1
(43) Pub. Date: Mar. 31, 2005

(54) Mask with patterned lighting

(76) Inventors: Don Post, Sherman Oaks, CA (US); Matthew Post, North Hollywood, CA (US)

Correspondence Address: Thomas J. Durling;DRINKER BIDDLE & REATH LLP, One Logan Square, 18th & Cherry Streets, Piladelphia, PA, 19103-6996, US

(21) Appl. No.: 10/675,978

(22) Filed: Sep. 30, 2003

(51) Int. Cl. F21V 21/084

(52) U.S. Cl. 362/105

(57) ABSTRACT

A device is provided for covering the wearer's face and eyes having a first masking layer which is adapted to cover at least a portion of the face of the wearer. The first layer generally conforms to the topography of the human face and has openings for the eyes of the wearer so that the wearer can see therethrough. A second masking layer is provided in a closely spaced relationship with the first masking layer. The second layer has eye openings in substantial registration with those of the first layer. A plurality of lamps are fixedly positioned between the first and second masking layers and electrically connected to a controller for activation of the lamps. The second masking layer is preferably translucent such that the activation of the lamps is visible therethrough.

### FIELD OF THE INVENTION

The present invention relates to a covering or mask for concealing the face and eyes of a wearer. More particularly, the present invention relates to a mask having a lighted pattern within the confines of the face covering.

### BACKGROUND OF THE INVENTION

Face masks, such as Halloween masks or the like, typically cover the wearer's face and are attached by an elastic band passing around the back of the head. Other more extensive masks cover the entire face and head of the wearer. Typically, face masks may be constructed of an opaque material with decorative features provided on the external surfaces thereof. Eye openings are provided in the mask to permit the wearer to see.

Lighting has been included in various masks in the past. U.S. Pat. No. 6,035,447 to Hsai describes a Halloween mask formed from resilient material. The mask includes a flashing device having a neck with a widened base. The flashing device is adapted to be inserted through a plurality of apertures provided in the mask. The widened base holds the flashing device in a selected aperture until removed by a wearer. Further, masks have been designed with a plurality of small light bulbs or LED's mounted on the exterior surface of the mask and connected by wires to a battery box worn on the user's waist.

U.S. Pat. No. 4,683,588 to Goldberg describes a face mask with voice modifying capability. The mask includes a light bulb (or an LED in) the center of each of a pair of fake eyes. A wire connects the bulbs, in series, to a battery through a toggle switch. The bulbs are adapted to flash on and off when the switch is closed. In U.S. Pat. No. 4,690,653, also to Goldberg, there is shown a mask having similar LED's in the center of the eyes. Circuitry is provided to periodically flash the LED's on and off to simulate blinking eyes.

U.S. Pat. No. 6,093,475 to Geller shows a mask with a simulated bleeding element formed from an opaque inner layer and a transparent or partially transparent outer layer which are joined by a sealing outer lip to define a closed package in between. An inlet in the top of the mask receives simulated blood or other fluid from a tube. The simulated blood flows through the passage into an outlet at the bottom. Tubes convey the simulated blood material from the mask outlet. A pump is provided to maintain the flow of simulated blood. The inner layer of the mask includes eye holes that are covered with black mesh having sufficient openings therein to enable a wearer to see out, yet small enough to prevent a distant observer from seeing the wearer's eyes. The mask also has a black shroud attached to the sealing lips and extending down to the shoulders of the wearer to conceal the inlet and outlet of the associated tubes.

U.S. Pat. No. 5,546,604 to Geller describes a hood with a concealing face mask. The face mask is formed from dark mesh that appears opaque from the outside and conceals the wearer's face and eyes while allowing the user to see through it. The face mask is attached to a hood having a tail piece and a cowl, which is a folded portion of the hood extending forward from the face mask.

Other mask arrangements are also known in the prior art, including masks having LED's or lamps positioned within facial orifices in the outer surface of the mask so that the orifices appear brighter than the remainder of the outer surface of the mask. In addition, U.S. Pat. No. 4,400,591 to Jennings, et al. shows a simulated space helmet with an array of LED's symmetrically arranged on the nose housing of the helmet. A driver unit selects a combination of LED's to be lit at any particular time based on the intensity of the audio signal being transmitted through the voice modulator.

### SUMMARY OF THE INVENTION

In one aspect of the present invention, a device for covering a wearer's face and eyes is provided having a first masking layer, a second masking layer and a plurality of lamps fixedly positioned between the first and second masking layers and electrically connected to a power source. The second masking layer is secured to the first masking layer in a closely spaced relationship. The first and second layers each have eye openings which are in substantial registration. The plurality of lamps are fixedly positioned between the two masking layers and are visible through the transparent and/or translucent material of the outer, second masking layer. A controller for actuating the lamps is also provided. The controller may also actuate the plurality of lamps in a desired pattern.

In further aspects of the present invention, the inner layer of the mask may comprise a substantially rigid, opaque material. A plurality of spacers may also be provided on the inside surface of the first masking layer so as to space the mask from the face of the wearer. A fabric hood or other head covering may also be provided, as well as eye screens that permit viewing by the wearer, yet limiting visibility by an observer of the wearer's eyes.

Further aspects of the invention may include a power source, such as small batteries or the like, which may be fixedly supported under the second masking layer such that it is not visible to an observer. The controller may comprise an activation switch which may be remotely positioned.

### BRIEF DESCRIPTION OF THE DRAWINGS

For purposes of illustrating the invention, there is shown in the drawings a form which is presently preferred; it being understood, that this invention is not limited to the precise arrangements and instrumentalities that are shown in these drawings.

FIG. 1 shows a front elevation of a mask as contemplated by the present invention.

FIG. 2 shows a front elevation of the combination of an inner masking layer portion and the power source and electrical controller for the plurality of lamps.

FIG. 3 shows an exploded view of the mask constituent parts.

FIG. 4 is a side cross sectional view of the mask components as positioned over the wearer's face.

### DETAILED DESCRIPTION OF THE DRAWINGS

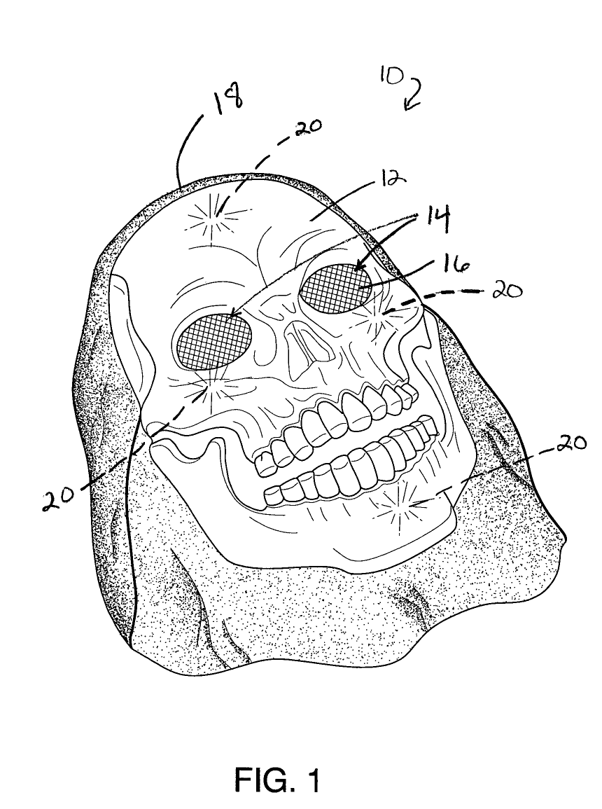

In the drawings, where like numerals indicate like elements, there is shown an embodiment of the present invention. As illustrated, the device comprises a mask which is generally identified by the numeral 10. In FIG. 1, the mask 10 is shown to have an outer masking layer 12 with two eye openings 14, which are covered by a screening material that permits the wearer (not shown in FIG. 1) to see through the openings 14, but hides the wearer's eyes from an outside observer. Attached to the outer masking layer 12 is a hood 18 which is illustrated comprised as a fabric type material. Visible through the outer masking layer 12 is a plurality of lamps 20. The lamps, when illuminated, are readily visible through the translucent material of the outer masking layer 12.

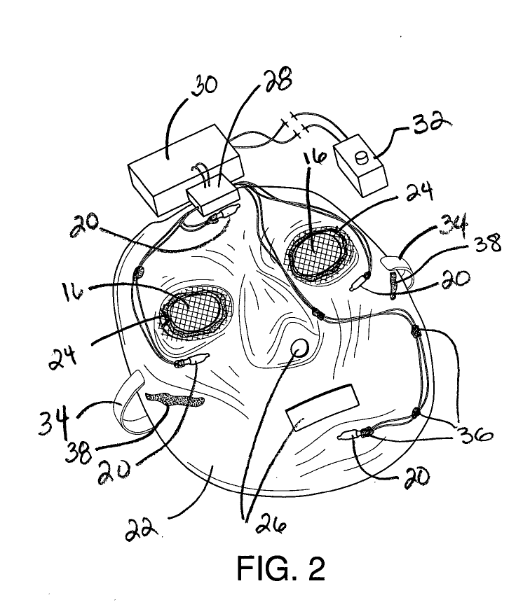

As illustrated in FIG. 2, the construction of the mask 10 comprises an inner masking layer 22 which generally conforms to the topography of the human face. The inner layer is preferably substantially rigid and made of a plastic material. A nose cup is provided in the surface of the inner layer, as are eye openings 24. The eye openings 24 of the inner masking layer 22 are contemplated to be in substantial registration with the eye openings 14 in the outer masking layer 12. Ventilation openings 26 are also provided in the nose cup and adjacent to the mouth of the wearer.

The plurality of lamps 20, as visible through the outer masking layer 12 (FIG. 1), are electrically connected through wires to a controller 28 and a power supply 30. A switch 32 is provided for activation of the lamps 20. The switch 32 is connected electrically through wires to the power supply 30/controller 28 combination and may be positioned remotely from the mask, as illustrated. A strap 34 is attached to the inner masking layer 22 and behind the rear surface of the mask. The strap 34 is used to secure the mask to the wearer's head. The strap may be made of an elastic material so as to permit easy release of the mask and to provide a comfortable fit.

The plurality of lamps 20 are secured to the surface of the inner masking layer 22 by means of an adhesive 36. The adhesive 36 secures the lamps 20 as well as the wires which run along the outer surface of the inner masking layer 22. Adhesive spots 38 are also provided for securing the inner masking layer 22 to the outer masking layer 12. The screen material 16 may also be secured to the periphery of the eye openings 24 of the inner masking layer 22 by means of an adhesive 40.

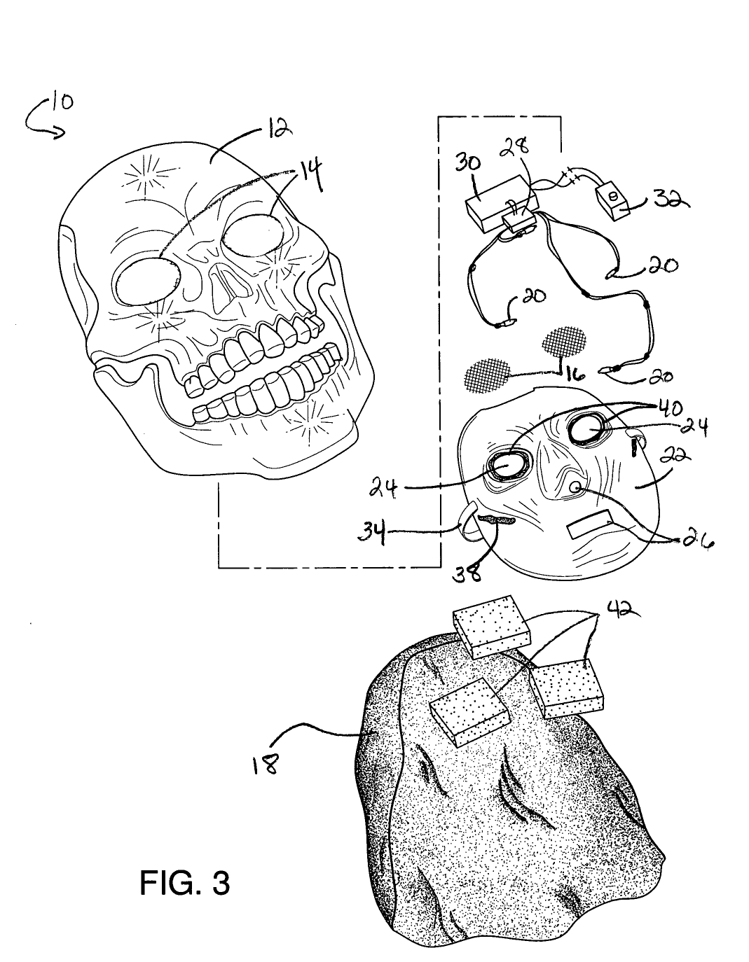

The assembly of the mask 10 is illustrated in FIG. 3 wherein the outer masking layer 12 is positioned over the inner masking layer 22, with the circuit formed by the lamps 20, controller 28 and power supply 30 sandwiched therebetween. The power supply 30 and controller 28 may be positioned between adjacent surfaces of the outer masking layer 12 and inner masking layer 22 or may be secured to only one of the layers.

Provided on the interior surface of the inner masking layer 22 are a series of spacer elements 42. The spacer elements 42 position the inner masking layer 22 away from the wearer's face when the mask is worn. The spacer elements 42 may be made of a soft or resilient material so as to increase comfort. The spacing of the mask from the wearer's face permits air flow along the inside surface of the mask and separates the lamps, which are mounted on the outer or top surface of the inner masking layer 22, from the face. The fabric hood 18 is contemplated to be attached to the upper rim of the outer masking layer 12 and/or at the joint between the outer and inner masking layers 12, 22.

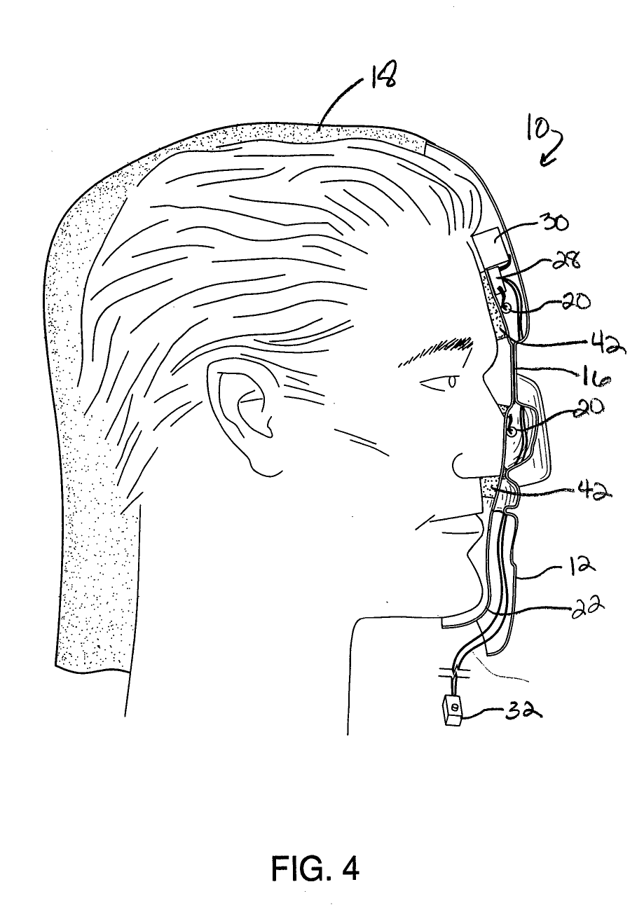

In FIG. 4 there is shown in cross section the mask 10, as previously described, positioned on a wearer's face. As illustrated, the spacer elements 42 are in contact with the face and position the inner masking layer 22 slightly above the surface of the face. The outer masking layer 12 is positioned in a closely spaced relationship with the inner masking layer 22. The outer layer 12 and the inner layer 22 are secured together by means of the adhesive 38 (FIG. 2). In the preferred embodiment, the edges of the outer masking layer are formed to come into contact at their edges so as to form a peripheral seal. As illustrated in FIG. 4, the bottom edges of the two layers are spaced from one another, as are the top edges. This open spacing further increases the air flow through the mask and dissipates the heat from the lamps and the breath of the wearer. Secured to the top edge of the inner masking layer 22 is the controller 28 and the power supply 30. The contemplated controller 28 will cause a patterned illumination of the lamps 20. The pattern may vary over time or alternate patterns may be selected by means of the switch 32. The power supply is contemplated to be portable batteries which can be replaced as desired. The circuitry of the activation is contemplated to provide a short interval of illumination. Upon the passage of the illumination period, the lamps shut down so as to conserve battery power. Thus, the wearer can control the activation of the lamps as desired.

The eye screen material is contemplated to be a woven fabric having sufficient openings to permit the wearer to see out. The screen material in combination with the darkness behind the mask creates a shadowing of the eyes of the wearer so that an observer facing the mask will not be able to clearly see the wearer's eyes. It is also preferred that the outer masking layer be a translucent and/or semi-transparent material so that the light from the lamps is visible once activated, although the lamp structure is not necessarily visible. The inner masking layer is preferably more opaque than the outer layer so as to not permit light to pass through, which would distract the wearer or possibly illuminate the wearer's facial surfaces.

The hood may be made of any desired material and is preferably sufficiently opaque so as to further hide the face and head. Other forms of head coverings may also be used with the mask 10. For example, the outer masking layer may be formed as a complete covering for the head.

The lamps as illustrated are low voltage light bulbs or may also comprise LED's or other illuminating devices. The controller may utilize any standard activation means to cause the flashing of the lights. The electrical circuit for the lamps (or their equivalent), the controller and the power supply is understood to readily fall within the skill of the relevant art.

Again, the present application describes a preferred embodiment. Upon reviewing the current description, those skilled in the art may be motivated to identify equivalent elements which may be substituted for those specifically described herein. The scope of the claims shall dictate the scope of the invention contemplated and not the preferred instrumentalities shown.

1. A device for covering a wearer's face and eyes, comprising:
a first masking layer adapted to cover at least a portion of the face of the wearer, the first layer having openings for the eyes of the wearer;
a second masking layer positioned over the first masking layer and secured thereto in a spaced relationship, the second masking layer having openings for the eyes of the wearer which are in substantial registration with the first layer openings;
a plurality of lamps fixedly positioned between the first and second masking layers; and
a controller for controlling the activation of the plurality of lamps in a desired pattern, the activation of the lamps being visible through the second masking layer which is positioned over the lamps.

2. The device as claimed in claim 1 wherein the second masking layer comprises a translucent material.

3. The device as claimed in claim 1 wherein the first masking layer comprises an opaque material.

4. The device as claimed in claim 1 further comprising a plurality of spacer elements secured to the inside of the first masking layer for positioning the first masking layer in a space relationship with respect to the wearer's face when the device is worn.

5. The device as claimed in claim 1 further comprising a hood which is secured to the peripheral edges of the second masking layer and which covers the rear of the wearer's head when the device is covering the wearer's face and eyes.

6. The device as claimed in claim 1 further comprising a screen material positioned over the eye openings, the screen material permitting visibility therethrough while screening the wearer's face and eyes that are positioned behind the eye openings.

7. The device as claimed in claim 1 wherein the controller further comprises a power source in the form of batteries.

8. The device as claimed in claim 1 wherein the controller causes a flashing pattern by the plurality of lamps upon their activation.

9. The device as claimed in claim 1 further comprising a switch for causing activation of the plurality of lamps.

10. A mask for covering a wearer's face and eyes, comprising:
an inner masking layer adapted to cover at least a portion of the face of the wearer, the inner layer being substantially rigid, having a topography that generally conforms to the contours of a human face and having openings for the eyes of the wearer;
a translucent outer masking layer positioned over the inner masking layer and secured thereto in a spaced relationship, the outer masking layer having a decorative front and having openings for the eyes of the wearer which are in substantial registration with the openings in the inner layer;
a plurality of lamps positioned at a plurality of locations between the inner and outer masking layers; and
a controller for activation of the plurality of lamps which are electrically connected thereto,
the translucent material of the outer layer permitting the light from the activated lamps to be visible while hiding the lamp structures and the electrical connections.

11. The mask as claimed in claim 10 further comprising a plurality of spacer elements secured to the inside of the first masking layer for positioning the first masking layer in a space relationship with respect to the wearer's face when the device is worn.

12. The mask as claimed in claim 10 further comprising a hood for covering the rear of the wearer's head when the mask is covering the wearer's face and eyes.

13. The mask as claimed in claim 10 further comprising a screen material positioned over the eye openings, the screen material permitting visibility therethrough while screening the wearer's face and eyes positioned behind the eye openings.

14. The mask as claimed in claim 10 wherein the controller causes a flashing pattern of the plurality of lamps upon activation.

15. The mask as claimed in claim 10 wherein the controller further comprises an activation switch for controlling activation of the plurality of lamps.

16. A mask comprising:
an inner masking layer adapted to cover at least a portion of the face of the wearer, the inner layer being substantially rigid and having a topography that generally conforms to the contours of a human face,
an outer masking layer positioned over the inner masking layer and secured thereto in a spaced relationship, the outer masking layer having a decorative front,
visibility openings provided in the inner and outer layers for the wearer to see through;
a plurality of lamps positioned at a plurality of locations within the space between the inner and outer masking layers; and
a portable power source and a controller for activation of the plurality of lamps which are electrically connected thereto,
the outer layer permitting the light from the activated lamps to be visible while hiding the lamp structures and the electrical connections.
